(19) United States
(12) Patent Application Publication
(10) Pub. No.: US 2024/0114851 A1
(43) Pub. Date: Apr. 11, 2024

(54) SYSTEM AND METHOD FOR SPECIALIZING LIGHT SPECTRA AND OPTIMIZING PHOTOSYNTHETIC CAPACITY TO ADJUST PLANT DIURNAL CYCLE

(71) Applicant: Local Bounti Corporation, Hamilton, MT (US)

(72) Inventors: Kate CROSBY, Hamilton, MT (US); Seth SWANSON, Missoula, MT (US); Andrew BARAO, Hamilton, MT (US); Jean YOST, Missoula, MT (US)

(73) Assignee: Local Bounti Corporation, Hamilton, MT (US)

(21) Appl. No.: 18/484,981

(22) Filed: Oct. 11, 2023

Related U.S. Application Data
(60) Provisional application No. 63/415,092, filed on Oct. 11, 2022.

(51) Int. Cl. A01G 9/24; A01G 9/18; A01G 9/26

(52) U.S. Cl. CPC A01G 9/249; A01G 9/18; A01G 9/26

(57) ABSTRACT

A method for growing plants may start by identifying at least the species of one or more plants being grown and selecting a spectra shift recipe from a menu of spectra shift recipes for the one or more plants based on the species identification of the one or more plants. Next, light may be emitted on the one or more plants. The light being emitted may be selected according to the selected spectra shift recipe. The spectra shift recipes may include, for example, a plurality of durations and at least a spectral category for each time, and the spectral category may cycle from no light to blue peak and back at least one time.

### FIELD

An exemplary embodiment relates to the field of controlled environment agriculture.

### BACKGROUND

Controlled environment agriculture (CEA) provides many advantages over traditional or conventional agricultural methods. For example, CEA may require a smaller footprint while producing a higher yield. The use of a controlled environment can allow variables such as light and temperature to be precisely specified. However, CEA still faces a number of challenges. For example, a risk of crop failure and a high risk of disease and virus outbreak still exists.

While CEA may improve growing speed when compared to traditional farms, improvements to expedite yield are still sought after. For example, providing the correct balance of nutrients may expedite growth of a plant, however, that may be specific to each varietal. However, current systems are not able to efficiently accelerate growth and development to meet demands.

Plants are typically adapted to the diurnal cycle of their natural environment. The day and night cycle of a plant may affect plant attributes. Processes such as respiration may occur at night when photosynthesis halts.

### SUMMARY

According to at least one exemplary embodiment a system and method for growing plants may be described. A method for growing plants may start by identifying at least the species of one or more plants being grown and selecting a spectra shift recipe from a menu of spectra shift recipes for the one or more plants based on the species identification of the one or more plants. Next, light may be emitted on the one or more plants. The light being emitted may be selected according to the selected spectra shift recipe. The spectra shift recipes may include, for example, a plurality of times and at least a spectral category for each time, and the spectral category may cycle from no light to blue peak and back at least one time.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary system for specializing light spectra and optimizing photosynthetic capacity.

FIG. 2 is an exemplary method for specializing light spectra and optimizing photosynthetic capacity.

FIG. 3 is an exemplary accelerated spectral cycle timetable.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequences of actions described herein can be performed by specific circuits (e.g. application specific integrated circuits (ASICs)) and/or by program instructions executed by at least one processor. Additionally, the sequence of actions described herein can be embodied entirely within any form of computer-readable storage medium such that execution of the sequence of actions enables the at least one processor to perform the functionality described herein. Furthermore, the sequence of actions described herein can be embodied in a combination of hardware and software. Thus, the various aspects of the present invention may be embodied in a number of different forms, all of which have been considered to be within the scope of the claimed subject matter. In addition, for each of the embodiments described herein, the corresponding form of any such embodiment may be described herein as, for example, “a computer configured to” perform the described action.

Referring to the figures generally, at least a method, system and apparatus for adjusting the diurnal cycle of a plant may be shown and described. Biological perceived photonic time (dark-light-dark cycle) of more than one day may be compressed into a single 24-hour period or expanded using spectral manipulation. Far red/red light (FR/R) at typical outdoor daily light integral begins a cycle and activates photosynthesis. The max photosynthetic rate (Amax) may be reached at a faster rate. Growth may be further accelerated by increasing the CO₂ level and concentrating the FR/R, Blue, Green, and UV-A spectrum at a specified day period in order of increasing energy intensity to decreasing energy intensity.

An exemplary embodiment may provide a method for increasing the rate at which the max photosynthetic rate of plants in a controlled environment is reached. The light shift may vary depending on species, origin, and genetics. A sensor system, which may include, for example, normalized difference vegetation index (NDVI) cameras, which may help identify the amount and overall health of live vegetation in an area by measuring, for example, chlorophyll production or photosynthetic rate (CO₂ assimilation rate). In other embodiments one or more plants may be tagged with, for example, RFID tags, and sensors may use the tags to identify the plants. An exemplary embodiment may be implemented on an integrated growing structure which may be vertical and can include artificial lights and/or natural lighting. The artificial lights may produce a specified light spectrum and/or intensity according to a specified schedule or recipe. The integrated growing structure or growing environment may be capable of increasing the amount of carbon dioxide around the plants. In an embodiment the artificial lights may be supplemented or augmented with the use of natural and/or filtered light.

In an exemplary embodiment, artificial lights on an integrated growing structure may be able to emit light in various spectrums and at various intensities, for example they may emit light on a portion of the FR/R light spectrum or emit light on a full light spectrum of an average summer day including UV light, or any other spectrum in between. The lights may, for example, go from no light, to far red light, to FR-R light, to FR-R light dominant spectrums that includes some blue light, to full spectrum light including UV, or anything in between as needed, and may also be able to increase or decrease the spectrum intensity. The lights may be able to move between spectrums at a specific rate, i.e. once, twice, three times a day etc. It may be understood that the rate may be variable depending on any number of factors. For example, it may increase more quickly as the day goes on or based on detected variables of the plants or growing facilities. In some embodiments the lights may be a specified blend of multiple spectrums, with the blend varying based on the schedule or recipe.

In an exemplary embodiment the lights moving between various light spectrums may emulate outdoor photonic time. As plants are exposed to FR/R of typical outdoor daily light integral (DLI) photosynthesis may be triggered. The lights may then ramp up through spectrum and intensity until they reach the spectrum of a full summer day including UV light, which may allow the plants to reach their max photosynthetic rate or “Amax”. Once the Amax is reached, the lights may then ramp back down to a portion of the FR/R spectrum or turn off, which may imitate an off or night period for the plants.

In an exemplary embodiment the light spectrum shift cycle may take 24 hours, thereby imitating a normal day. In other embodiments the spectrum shift cycle may be adjusted. For example, the spectrum shift cycle may be adjusted in duration, shorter or longer, and/or intensity. According to some exemplary embodiments the cycle may be adjusted to take less than 24 hours, for example there may be two cycles per day where each cycle takes 12 hours, thereby allowing for multiple “plant time perceived days” within one normal day. In other embodiments other cycle times may be used, for example 8 hours, 6 hours, or any other amount of time. In other embodiments the cycle may take longer than a day, for example 36 hours or 48 hours. Still further, the system may utilize a combination of varied cycle times. For example, in some embodiments a first cycle time may be used during an initial growth stage while a second cycle time may be used for a second growth stage, or the cycle time may be adjusted due to detected abnormalities in plant growth.

In an exemplary embodiment, CO₂ levels in the controlled environment may be increased in time with the changing light cycle in order to further promote plant growth. For example, CO₂ may be increased above atmospheric levels of 400 ppm. The increase in CO₂ may mimic the increasing light and may reach maximum concentration when the light is at maximum intensity and spectrum. Likewise, when the light spectrum and intensity decreases the CO₂ may also decrease and reach its minimum during the off or night cycle. In other embodiments the CO₂ may be adjusted independent of other factors such as the light.

In an exemplary, embodiment spectra shift recipes may be developed, which may include the spectra shift time period, rate of decrease or increase, what specific light spectra are used, how long the full light or night periods are, the intensity of the light, etc. The spectra shift recipes may be tailored to fit a specific crop species, crop origin, crop genetic, morphological or biomass objectives or group of any of these. In some embodiments a plurality of recipes may be developed and stored, for example in a database, which may then be accessed when determining a recipe to use on a specific plant or group of plants.

In an exemplary embodiment plants may be bred to favor specific light cycle genes, for example some plants may have long day (LD) genes, while others may have short day (SD) genes. SD gene plants may be compatible with shortened day cycles, and so plants with SD genes may be selectively bred for optimal utilization of shorter cycles. Furthermore, other traits that are compatible with spectra shifts may be selectively bred for, for example, plants that are used to living in extreme north latitudes may be better adopted for shorter day cycles. In some embodiments the SD/LD photoperiod of a plant may be a driver of the generative phase of plant growth. Therefore, the alternative lighting spectrum may allow for expediting the growth cycle while managing floral cues. In some embodiments shortening night cycles below a plant's critical period may create an artificial LD even if the day is shortened.

In an exemplary embodiment a monitoring or sensor system, such as a normalized difference vegetation index (NDVI) camera may be used to monitor the plants by, for example detecting the amount of live vegetation in a given area or by detecting the amount of chlorophyll produced in a plant or the photosynthetic rate of the plant to indicate overall health, and using that to infer when Amax is reached. In other embodiments different sensors or systems may be used, for example a portable photosynthesis system. Feedback from the sensor system may facilitate changes or adjustments to be dynamically made to the spectra shift recipe as the plants grow. For example, if Amax is reached faster than expected then the cycle time may be dynamically shortened.

In an exemplary embodiment the method for specializing light spectra may be used, for example, for fast generation of small plants, growing perennial berries, speed breeding. Furthermore, the small plant may be cloned to preserve its genetics, particularly where the plant has been bred to be compatible with the shortened photonic time.

In an exemplary embodiment genetics may be selected that are well adapted for a specific cycle time. For example, varieties of plants that perform well at a highly positive or negative latitude may be well adapted to these shifts. Furthermore, other traits, such as stomatal density, may be bred for in order to increase cycle time compatibility.

In an exemplary embodiment the plants may be grown in a structure that maximizes the use of spectral shifts, thereby allowing for greater scalability. Furthermore, the system may be implemented or arranged such that it can be tailored to one or more unique species within a grow environment.

In an exemplary embodiment, the spectral shift recipe may take place in an integrated growing structure or environment, which may be able to manipulate other environmental conditions in order to maximize plant growth and/or plant response to the spectra shift recipes. Conditions manipulated may include, but are not limited to, temperature, relative humidity, soil type, CO₂ levels, nutrient concentrations and proportions, etc. These conditions may be selected to maximize desired plant growth and development outcomes. Conditions may be constant or may change according to or in step with other changes to the spectra shift recipe such as light intensity.

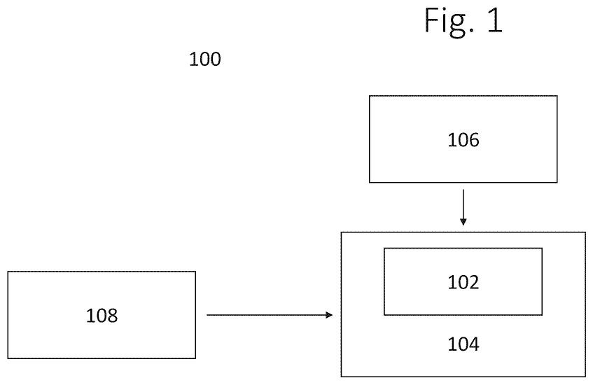

Referring now to FIG. 1, FIG. 1. may show an exemplary system for specializing light spectra and optimizing photosynthetic capacity 100. The system 100 may contain a plurality of plants 102. The plurality of plants 102 may be contained in a controlled environment 104, such as an indoor grow room or a vertical growing structure in order to maximize growth efficiency. The system 100 may further have a plurality of lights 106 which are able to shift between multiple spectrums, including at least FR/R and the spectrum of, for example, a full summer day. There may also be one or more sensors 108, such as an NDVI camera, heat sensors, humidity sensors, CO₂ detectors, atmospheric sensors, other cameras, etc. which may detect plant health during growth.

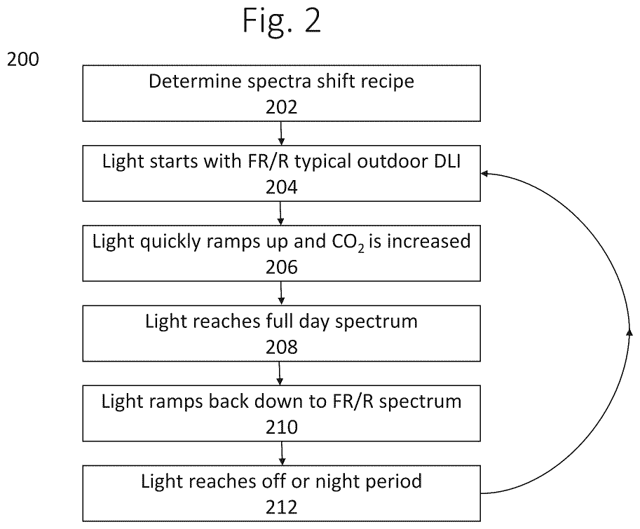

Referring now to FIG. 2, FIG. 2 may show an exemplary method for specializing light spectra and optimizing photosynthetic capacity 200. In a step 202 a spectra shift recipe may be determined for one or more plants being grown.

In some embodiments the spectra shift recipe may be selected from a menu or plurality of spectra shift recipes. The determination or selection may be based on one or more factors including, but not limited to, the species of the plant being grown, the geographic location the plant is from, the genetics or genetic modifications of the plant, the age or stage of growth of the plant, or other external factors such as a targeted growth completion date or expected demand for a time or area. In some embodiments the spectra shift recipe may be automatically selected by a computer system or other device. The computer system or other device might further have access to one or more databases, for example a spectra recipe database, an expected demand database or a database with sale order amounts and dates.

In a step 204 the light may start with a FR/R light spectrum that emulates typical outdoor DLI, which may start photosynthesis of the plants being grown. In a step 206 the light may ramp up through light spectra according to the spectra recipe, and the CO₂ may be increased as called for in the spectra recipe. In a step 208 the lights may reach the full day light spectrum and may stay at full light for a period of time according to the spectra shift recipe. In a step 210 the lights may ramp back down to FR/R spectrum light according to the spectra recipe, and CO₂ may be decreased as called for in the spectra recipe. In a step 212 the lights may reach an off or night period, and may stay in the off period for a period of time according to the spectra shift recipe. Finally, after the off period the lights may return to step 204 and repeat the process until the spectra shift recipe is finished, for example at the time plant growth is finished.

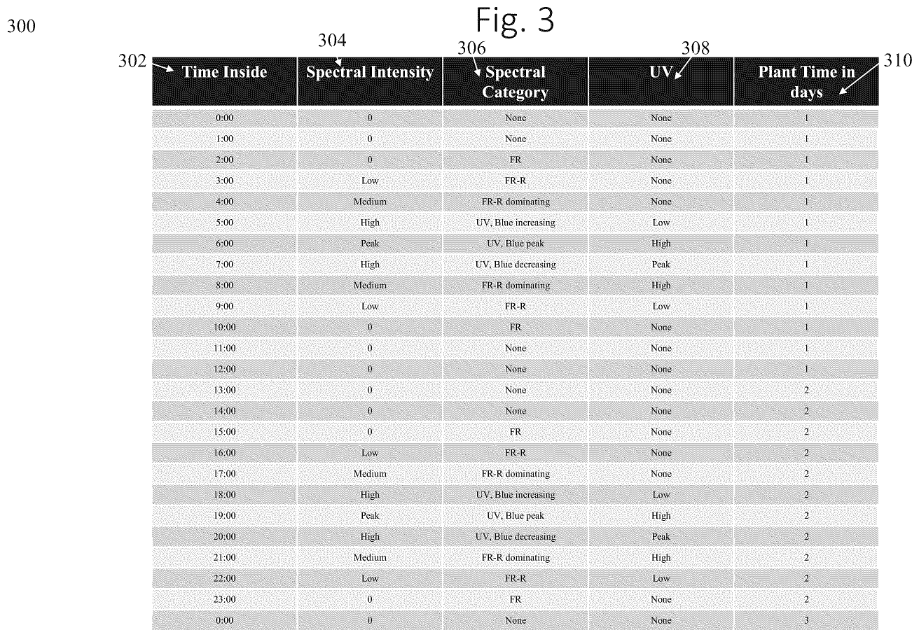

Referring now to FIG. 3, FIG. 3 may show an exemplary accelerated spectral cycle timetable 300. The timetable 300 may show actual time inside the facility 302, for example starting at 0:00 and going through an entire day in one hour increments. The timetable 300 may also show spectral intensity 304 being emitted by the lights at any given time, such as whether the spectral intensity is low, high, peak, etc. The timetable 300 may further show a spectral category 306 of the light being emitted by the lights. The spectral category may be, for example, FR, FR-R, FR-R dominating, UV blue increasing, UV blue peak, or UV blue decreasing. The timetable 300 may further show how much UV light 308 is being emitted by the lights. The UV light 308 being emitted may be, for example, low, high, or peak. Finally, the timetable 300 may show how many biologically perceived days 310 have passed for plants inside the facility. For example, after one full spectral cycle has passed the plants may be on their second perceived day 310, even if a full day of actual time has not passed.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for growing plants comprising:
identifying at least a species of one or more plants being grown;
selecting a spectra shift recipe from a menu of spectra shift recipes for the one or more plants based on the species identification of the one or more plants;
emitting light on the one or more plants, wherein a spectrum of the light being emitted is selected according to the selected spectra shift recipe;
wherein the spectra shift recipes comprise a plurality of durations and at least a spectral category for each duration, and the spectral category cycles from no light to blue peak and back at least one time.

2. The method for growing plants of claim 1, wherein the one or more plants are being grown in a greenhouse or other indoor growing environment.

3. The method for growing plants of claim 1, wherein the spectra shift recipes further comprises at least a spectral intensity.

4. The method for growing plants of claim 3, wherein the spectra shift recipes further comprises at least a UV light intensity.

5. The method for growing plants of claim 1, wherein identifying at least the species of the one or more plants being grown further comprises identifying one or more of a geographic origin and/or genetics of the one or more plants.

6. The method for growing plants of claim 1, wherein the identifying at least the species of one or more plants is done by one or more sensors.

7. The method for growing plants of claim 4, further comprising;
monitoring the one or more plants being grown using one or more sensors; and
dynamically adjusting the spectra shift recipe based on the one or more sensors monitoring the one or more plants being grown.

8. The method for growing plants of claim 7, wherein the one or more sensors monitoring the one or more plants being grown include at least a normalized difference vegetation index (NDVI) camera.

9. The method for growing plants of claim 2, wherein the spectra shift recipes further comprise at least CO2 levels in the greenhouse or other indoor growing environment.

10. A system for growing plants comprising:
one or more plants being grown;
one or more sensors configured to identify at least a species of the one or more plants being grown;
a spectra shift recipe selected from a menu of spectra shift recipes based on the species identification of the one or more plants;
one or more lights, wherein the one or more lights are configured to emit light on the one or more plants according to;
wherein a spectral category of the light emitted by the one or more lights cycles from no light to blue peak and back at least one time; and
wherein the spectra shift recipes comprise a plurality of durations and at least a spectral category for each duration.

11. The system for growing plants of claim 10, further comprising a greenhouse or other indoor growing environment, wherein the one or more plants are being grown in a greenhouse or other indoor growing environment.

12. The system for growing plants of claim 10, wherein the spectra shift recipes further comprise at least a spectral intensity for each of the plurality of durations.

13. The system for growing plants of claim 12, wherein the spectra shift recipes further comprise at least a UV light intensity for each of the plurality of durations.

14. The system for growing plants of claim 10, wherein identifying at least the species of the one or more plants being grown further comprises identifying one or more of a geographic origin and/or genetics of the one or more plants.

15. The system for growing plants of claim 13, further comprising one or more monitoring sensors which monitor the one or more plants being grown, wherein the spectra shift recipe is dynamically adjusted based on the one or more monitoring sensors.

16. The system for growing plants of claim 15, wherein the one or more monitoring sensors include at least a normalized difference vegetation index (NDVI) camera or chlorophyll fluorescence sensor.

17. The system for growing plants of claim 11, wherein the spectra shift recipes further comprise at least a CO2 level in the greenhouse or other indoor growing environment for each of the plurality of durations.
